(19) United States
(12) Patent Application Publication
(10) Pub. No.: US 2008/0052279 A1
(43) Pub. Date: Feb. 28, 2008

(54) Device and network capable of providing personalized services

(76) Inventors: Sunil Marolia, Laguna Niguel, CA (US); Glenn Hamasaki, Mission Viejo, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/827,583

(22) Filed: Jul. 12, 2007

Related U.S. Application Data
(60) Provisional application No. 60/830,542, filed on Jul. 12, 2006.

(51) Int. Cl. G06F 17/30; G06F 7/10

(52) U.S. Cl. 707/3; 707/104.1; 707/E17.009; 707/E17.014

(57) ABSTRACT

A method and system for interfacing to an electronic device is disclosed. At least one server may gather Information from the electronic device, which may be, for example, a mobile terminal. Information may also be gathered regarding the user of the mobile terminal. At least one user profile may be generated based on the gathered information. Information may then be sent to the mobile terminal based on the at least one user profile generated.

The present application makes reference to, claims priority to, and claims benefit of U.S. Provisional Application Ser. No. 60/830,542 entitled “DEVICE AND NETWORK CAPABLE OF PROVIDING PERSONALIZED PHONE SERVICES”, filed Jul. 12, 2006, the complete subject matter of which is hereby incorporated herein by reference, in its entirety.

### BACKGROUND OF THE INVENTION

Electronic devices, such as, for example, mobile phones and personal digital assistants (PDA's), may be personalized by a user. The user may select, for example, a ring-tone and/or a wall-paper that may be pre-loaded on to the electronic device. Different electronic devices may have different sets of resources, different sets of parameters, etc., that may need to be changed for personalization.

Further limitations and disadvantages of conventional and traditional approaches will become apparent to one of skill in the art, through comparison of such systems with the present invention as set forth in the remainder of the present application with reference to the drawings.

### BRIEF DESCRIPTION OF SEVERAL VIEWS OF THE DRAWINGS

FIG. 1A is a perspective block diagram of an exemplary network that supports remote update of non-volatile memory of an electronic device such as, for example, a mobile handset or personal digital assistant, in accordance with an embodiment of the invention.

FIG. 1B is a perspective block diagram of a network that is capable of determining the personalization needs of an electronic device, in accordance with an embodiment of the invention.

FIG. 1C is a perspective block diagram of personalization and promotion components, in accordance with an embodiment of the invention.

FIG. 2A is a perspective block diagram of an exemplary device management network that supports multiple management authorities using a multiple management authority framework, in accordance with an embodiment of the invention.

FIG. 2B is a perspective block diagram of an exemplary device management network that supports multiple management authorities using a multiple management authority framework, in accordance with an embodiment of the invention.

FIG. 3 is a flowchart of an exemplary method supporting delivery of personalized information via a network from at least one server to an electronic device of a user, in accordance with an embodiment of the invention.

FIG. 4 is a flowchart of an exemplary method to push promotions based on user input preferences, in accordance with an embodiment of the invention.

FIG. 5 is a flowchart of an exemplary method for dynamic personalized content of user input preferences, in accordance with an embodiment of the invention.

FIG. 6 is a flowchart of an exemplary method to push promotions based on auto-derived preferences, in accordance with an embodiment of the invention.

FIG. 7 is a flowchart of an exemplary method for dynamic personalized content of auto-derived preferences, in accordance with an embodiment of the invention.

FIG. 8 is a flowchart of an exemplary method to push promotions based on on-line community preferences, in accordance with an embodiment of the invention.

FIG. 9 is a flowchart of an exemplary method for dynamic personalized content of auto-derived preferences and on-line community preferences, in accordance with an embodiment of the present invention.

FIG. 10 is a flowchart of an exemplary method for personal profile sharing, in accordance with an embodiment of the invention.

### DETAILED DESCRIPTION OF THE INVENTION

Aspects of the present invention relates generally to the personalization of mobile devices, and, more specifically, to the installation and updating of new services on the mobile devices. While the following discussion focuses primarily on mobile terminals such as, for example, a mobile handset, a cellular phone, a personal digital assistant, a pager, and a handheld personal computer, this is by way of example and not by way of specific limitations of the present invention. The teachings contained herein may also be applicable to a variety of other electronic devices for which personalization may be desirable, and also where a user of the electronic device may wish to receive promotions/advertisements regarding items/events of interest to the user.

Representative embodiments of the invention may be employed for personalization of electronic devices using wired or wireless communication links such as, for example, a public switched telephone network, a wired local or wide area network, an intranet, the Internet, and wireless cellular, paging, local area, personal area, and short range networks such as those referred to as WiFi, IEEE 802.11a/b/g/n compatible networks, the short range wireless technology known as Bluetooth, and similar types of communication links. In an embodiment of the invention, information regarding the user and/or the electronic device may be entered, for example, by the user during the activation process and/or during use of the device. The information may also be gathered from the electronic device directly and/or various databases that may contain information regarding the user and/or the electronic device.

Personalization may comprise, for example, configuring streaming parameters, configuring shortcuts, adding and managing bookmarks, downloading ring-tones and wallpapers, downloading firmware components, downloading applications, downloading classes, libraries, and drivers, and setting up softkeys.

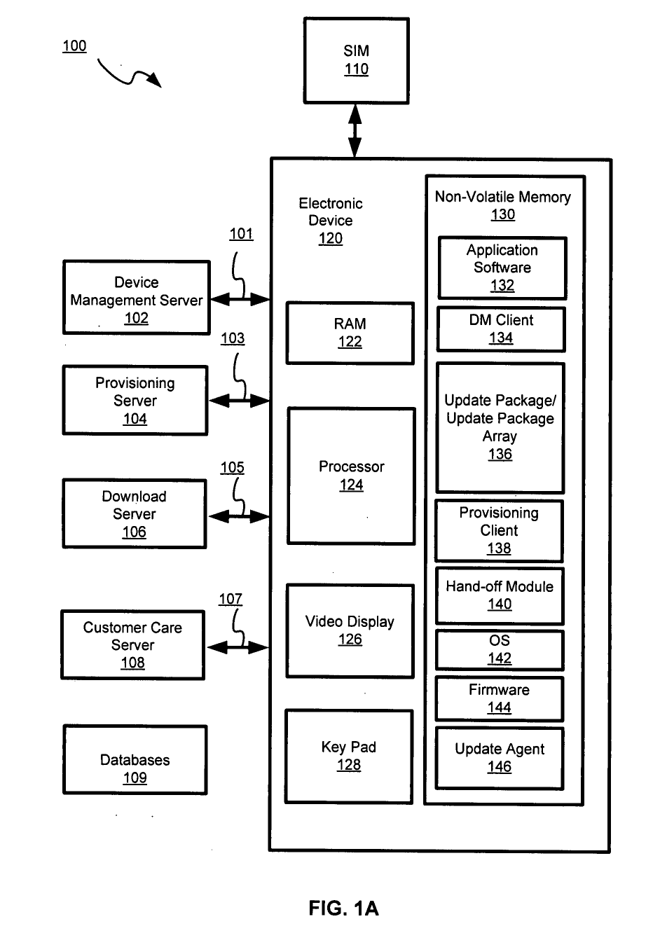

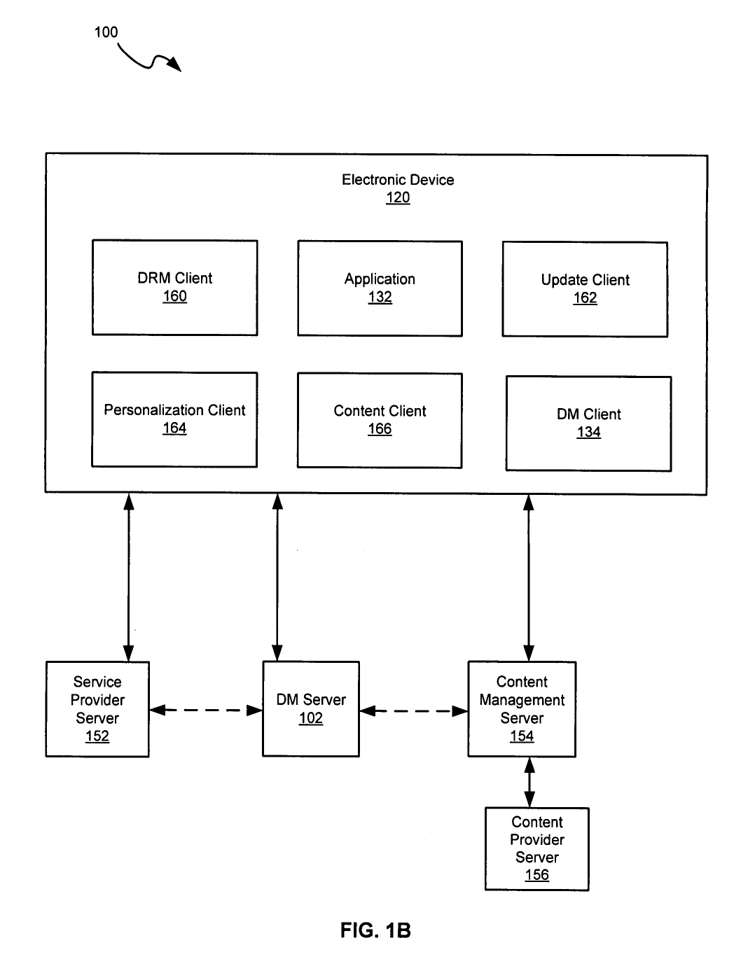

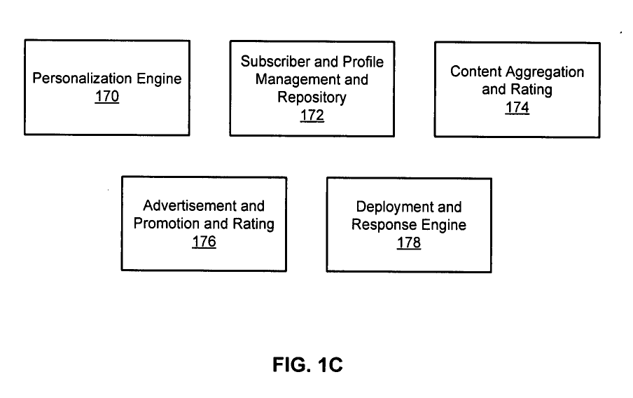

FIG. 1A is a perspective block diagram of an exemplary network 100 that supports remote update of non-volatile memory of an electronic device 120 such as, for example, a mobile handset or personal digital assistant, in accordance with an embodiment of the present invention. The electronic device 120 may, for example, comprise a cellular phone, a personal digital assistant (PDA), a pager, a handheld personal computer (PC), and/or the like. The electronic device 120 may support a number of features and/or applications that may contain software/firmware errors that need to be corrected, or that may provide additional features/benefits by updating the software/firmware. The electronic device 120 may itself be used to request updates to software/firmware via a customer care server 108 either directly, using a browser in the electronic device 120, or via a customer service representative (CSR). A CSR may, for example, provide service to the customer using the electronic device 120 by retrieving, as necessary, one or more diagnostic management objects (MOs) stored in memory of the electronic device 120, and by transmitting to the electronic device 120 from a remote server, update information in the form of, for example, one or more update packages. Such update packages may, for example, comprise instructions to code in the electronic device 120 to convert or transform a first version of software/firmware to a second version of software/firmware, in the electronic device 120, in addition to metadata, and checksum information.

As shown in the illustration of FIG. 1A, the network 100 in an embodiment of the present invention may comprise the electronic device 120, a device management (DM) server 102, a provisioning server 104, a customer care server 108, and a download server 106. Although not illustrated in FIG. 1A, an embodiment of the invention may also comprise other application servers such as, for example, a diagnostics server, and a self-care website/portal. The electronic device 120 is able to communicate with the DM server 102, the download server 106, the customer care server 108, and the provisioning server 104 via communication paths 101, 103, 105, and 107, respectively. Although the communication paths 101, 103, 105, and 107 are illustrated as being separate paths between the electronic device 120 and their respective servers, this is only for purpose of illustration, and is not a specific limitation of an embodiment of the invention. The communication paths 101, 103, 105, and 107 may be combined into one or more paths that may comprise wired or wireless communication paths such as, for example, a local area network, a public switched telephone network, a wireless personal, local or wide area network, and a cellular or paging network, to name only a few possibilities.

As illustrated in FIG. 1A, an electronic device in accordance with an embodiment of the invention may comprise random access memory (RAM) 122, a processor 124, a video display 126, a keypad 128, and non-volatile memory (NVM) 130. The NVM 130 may comprise, for example, NAND or NOR type flash memory or other suitable type of NVM. The NVM 130 may contain a number of software/firmware code components of the electronic device 120 including, for example, application software 132, a device management (DM) client 134, an update package/update package array 136, a provisioning client 138, a hand-off module 140, an operating system (OS) 142, firmware 144, and one or more update agent(s) 146. Additional software/firmware code components may also be present in the RAM 122 and NVM 130.

The term “code” may be used herein to represent one or more of executable instructions, operand data, configuration parameters, and other information stored in memory of the electronic device 120, and the term “update package catalog” may be used interchangeably with the term “update package array” to refer to received update information that comprises multiple update packages. The electronic device 120 may also comprise interface circuitry (not shown) to enable operable connection of a subscriber identity module (SIM) card 110, that may be employed in accordance with aspects of the present invention described later in this document.

In an embodiment of the invention, an electronic device such as, for example, the electronic device 120 may employ an update package (e.g., the update package/update package array 136) delivered by a remote server such as, for example, the download server 106, to update firmware/software, data and configuration information in memory of the electronic device 120. Such an update package may comprise update information including, for example, metadata describing an update, checksums, and instructions executable by one or more update agents such as, for example, the update agent 146. The update agent 146 may process a set of executable instructions, which may be used as a compact means to encode differences between existing/first and updated/second versions of firmware, software, data, and configuration parameters for the electronic device 120. The executable instructions may be assembled into update packages to be transmitted to an electronic device for use in updating memory of the electronic device. Update agent(s) 146 in the electronic device may process respective portions of the executable instructions from an update package to convert/transform corresponding portions of an existing/first version of code in memory of the electronic device 120 to portions of an updated/second version of code. The electronic device 120 may also receive provisioning information from, for example, the device management server 102, the provisioning server 104, and/or the customer care server 108 to fix configuration problems or reconfigure software and hardware.

In addition to those elements described above, the electronic device 120 may comprise a downloaded diagnostic client (not shown) that facilitates remote diagnosis, and a traps client (not shown) that facilitates the setting of traps and retrieving of collected information. The DM client 134 of the electronic device 120 may interact with the DM server 102, the diagnostic client, and the traps client, to receive DM commands from the DM server 102 and to implement them in the electronic device 120. The download server 106 may be employed to download firmware and software updates (e.g., update information in the form of, for example, update packages). The download server 106 may also be used to download new firmware/software such as, for example, the diagnostics client mentioned above, which may then be installed and activated in the electronic device 120.

As described briefly above, an electronic device in accordance with an embodiment of the invention (e.g., electronic device 120) may receive update information (e.g., an update package) for processing by one or more update agents (e.g., update agent 146) to convert/transform software (e.g., application software 132) and/or firmware (e.g., firmware 144) to produce updated software/firmware in the electronic device. In some embodiments of the invention, the update agent 146 may comprise multiple update agents. Each of the update agents may be appropriately arranged to process different types of update information for updating different types/formats of software, firmware, user data, and configuration parameters in the memory of the electronic device 120. Each of the update packages received may be processed in the electronic device by an appropriate one of the update agent(s) 146 to update an associated type of information in the memory of the electronic device 120.

In an embodiment of the invention, an Open Mobile Alliance (OMA) device management (DM)-based applications server may be composed of two parts, an OMA DM-based application, and an OMA DM server such as, for example, the DM server 102 shown in FIG. 1A. An OMA DM-based application is mainly focused on business processes, logic, and data. An OMA DM server, however, is mainly focused on the functionality required to support the OMA DM protocol by which the OMA DM-based application manipulates OMA DM-capable electronic devices such as, for example, the electronic device 120.

Additionally, there may be databases 109 that may be used to store various information, including subscriber information. The databases 109 may be a distributed database system spread out among various servers, or the databases may be centrally located on one server. Some exemplary databases may be billing records, service subscription records, subscriber profile records, and/or other databases to which the network 100 may have access. The database implementation may be design dependent.

FIG. 1B is a perspective block diagram of a network that is capable of determining the personalization needs of an electronic device, in accordance with an embodiment of the invention. FIG. 1B is a perspective block diagram of a network 100 that is capable of determining the personalization needs of an electronic device 120, which may be, for example, a mobile device, wherein the electronic device 120 supports several features that may be personalized. The electronic device 120 can be used to request personalization service via a content manager server 154. The content manager server 154 can be used to provide a service to the customer of the electronic device 120, by retrieving, for example, one or more personalization content and forwarding it to the electronic device 120.

The network 100 is capable of supporting personalization requests by the customer/subscriber of the electronic device 120 who might need to personalize their device features, email delivery, application options, device look and feel, language support, content delivery, subscriptions to services, etc.

In accordance with a representative embodiment of the invention, personalization profiles can be created and used by the network 100 for specific device features or applications. The network 100 may be capable of supporting requests for personalization by the customer/subscriber of the electronic device 120. The network 100 may appropriately personalize the electronic device 120 based on the preferences of the user/subscriber and based on device information retrieved from the electronic device 120.

The mobile network 100 comprises a device management (DM) server 102, the electronic device 120, a service provider server 152, a content management server 154, and a content provider server 156. The electronic device 120 is capable of updating an application software 132, an operating system (OS) 160, or a firmware in the electronic device 120 employing an update package delivered by the download server 106, using the services of the update client 162, as necessary. It is also capable of receiving provisioning information from the DM server 102 to fix configuration problems or reconfigure software and hardware.

The electronic device 120 comprises a DM client 134 that is capable of interacting with the DM server 102. The DM client 134 may also interact with the personalization client 164 and the diagnostic content client 166. The DM client 134 may be able to implement DM commands from the DM server 102. The content management server 154 is used to download content of various kinds, based on application profiles provided by the application 132 or based on a device profile provided by the electronic device 120. The content server 154 also provides the downloadable applications and other types of client software that can be installed and activated in the electronic device 120.

The personalization client 164 in the electronic device 120 provides support for collecting different kinds of personalization parameters, configuration information, user preferences, user menu selections, user initiated requests, etc. The personalization client 164 may also provide the capability to monitor device activities, memory configurations, application configurations, software installation preferences, etc., to aid in the personalization of the electronic device 120.

In a representative embodiment, the present invention provides for a device management (DM) approach wherein personalization management objects (MOs) are created and used for each feature domain or application that can be personalized. Each application installed in the mobile device 120 may provide an associated personalization MO that gets installed, and the content management server 154 or the DM server 102 can query or manipulate, (via the DM server 102 if necessary), to perform personalization. The content management server 154 communicates with the DM server 102 via an interface, such as a web services interface. Similarly, the service provider server 152 interacts with the DM server 102 via web services interfaces.

In one embodiment, if a user of the electronic device 120 installs an application, an alert is sent to the DM server (or to other services via the DM server 102) to personalize the installed application. Thus, applications and/or service installed by a user may also be personalized.

Operators/service providers associated with the mobile network 100 may enable/disable device capabilities as needed, based on data collected from the electronic device 120. For example, if the electronic device 120 supports various features of an application, but one of those features is not properly configured, the operator may disable (temporarily or permanently) that feature in the device until the device is properly configured.

When a subscriber visits a website that enables him to perform a remote diagnostic session over the air, identify the problem(s), and initiate one or more resolution processes, the network provides the services necessary to conduct such operations. In an exemplary scenario, a subscriber A visits a mobile subscriber self-care website. An embodiment of the invention may act as a traffic controller, or hub, for subscriber A's mobile experience to increase service, device interoperability, delivery, and enablement. Various embodiments of the invention may be used to interact with operators, OEMs, third party application developers, etc. to provide personalized services for the subscriber A.

In an embodiment of the invention, a subscriber who encounters a problem using his electronic device may enter his phone number, device model, and operator on a web site (or on the device) when prompted. A comment box may also be provided so that a subscriber can list additional information about the problem. The subscriber may then initiate an over-the-air diagnostic session. The diagnostic session can either use an existing proprietary diagnostic client or the OMA DM protocol to communicate with, for example, the DM server 102.

Device information such as, for example, IMEI (ESN), firmware version, applications resident (associated metadata), and signal strength are gathered from the device. The subscriber/operator specific information may also be gathered via the electronic device. Also, service level information such as application metadata may also be gathered. Once the device, subscriber/operator, and service level information is gathered, a personalization engine 170 of FIG. 1C may search for conflicts, dependencies, or other outstanding issues. The personalization engine 170 may be, for example, part of another server, or it may be viewed as a separate functionality. The personalization engine 170 is described in more detail with respect to FIG. 1C.

A conflict may exist, for example, in a device with a certain IMEI, firmware version, and software application, that may have runtime conflicts with a third party application that was downloaded to the electronic device. Once information is gathered and analysis is complete the problems can be displayed to the subscriber. The subscriber may then select the appropriate resolutions. The correct firmware images, software applications, and parameters can then be gathered from various components of the network 100 and delivered to the electronic device.

FIG. 1C is a perspective block diagram of personalization and promotion components, in accordance with an embodiment of the invention. As shown in the example of FIG. 1C, the promotion and personalization components comprise a personalization engine 170, a subscriber profile management block 172, a content aggregation and rating block 174, an advertisement and promotion and rating block 176, and a deployment and response engine 178. The personalization engine 170 comprises suitable code that can algorithmically generate subscriber profiles based on preferences input from the subscriber, information from the electronics device used by the subscriber, and information from the databases 109, and online web sites. The subscriber profiles can also be stored in portions of the databases 109. The algorithm(s) used in the personalization engine 170 may be design dependent.

The subscriber profile management block 172 comprises suitable code that provides storage and access to subscriber profiles used for determining subscriber specific content and promotion relevance. The terms subscriber and user may be used herein interchangeably. The term promotion may also be used herein to refer to advertisements. The subscriber profile management block 172 can also allow a subscriber to update profiles, and to share profiles with other subscribers. The algorithm(s) used in the subscriber profile management block 172 may be design dependent.

The content aggregation and rating block 174 comprises suitable code that is able to categorize available content and dependency metadata for assessing relevance based on a subscriber profile. The algorithm(s) used in the content aggregation and rating block 174 may be design dependent. The advertisement and promotion and rating block 176 comprises suitable code that is able to categorize available promotions with dependency metadata for assessing relevance based on a subscriber profile. The algorithm(s) used in the advertisement and promotion and rating block 176 may be design dependent.

The deployment and response engine 178 comprises suitable code that is able to handle deployment of personalized content and promotions based on target demographic objectives. The deployment and response engine 178 may support both automated periodic updates to devices as well as targeted campaigns. The deployment and response engine 178 may also provide a dependable response channel for measuring promotion take rates. The algorithm(s) used in the deployment and response engine 178 may be design dependent.

The promotion and personalization components can be resident, for example, in one or more servers such as the DM server 102, the service provider server 152, the content management server 154, the content provider server 156, and/or other appropriate servers. The servers where the promotion and personalization components can reside may be design dependent. Additionally, other embodiments of the invention may group the functionality of the promotion and personalization components under different names. For example, the content aggregation and rating block 174 and the advertisement and promotion and rating block 176 may be grouped together as a content and promotion block.

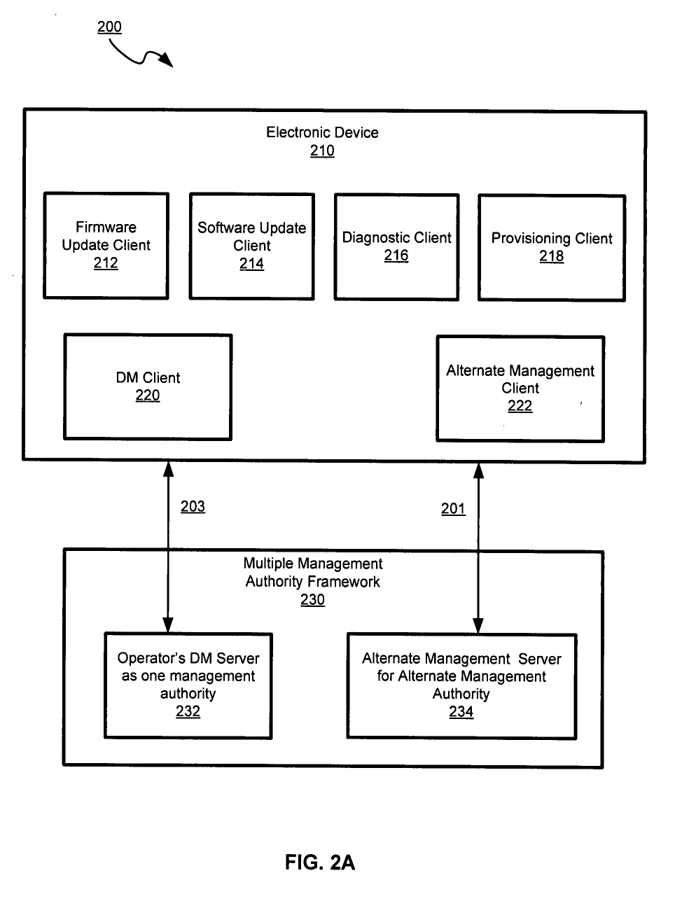

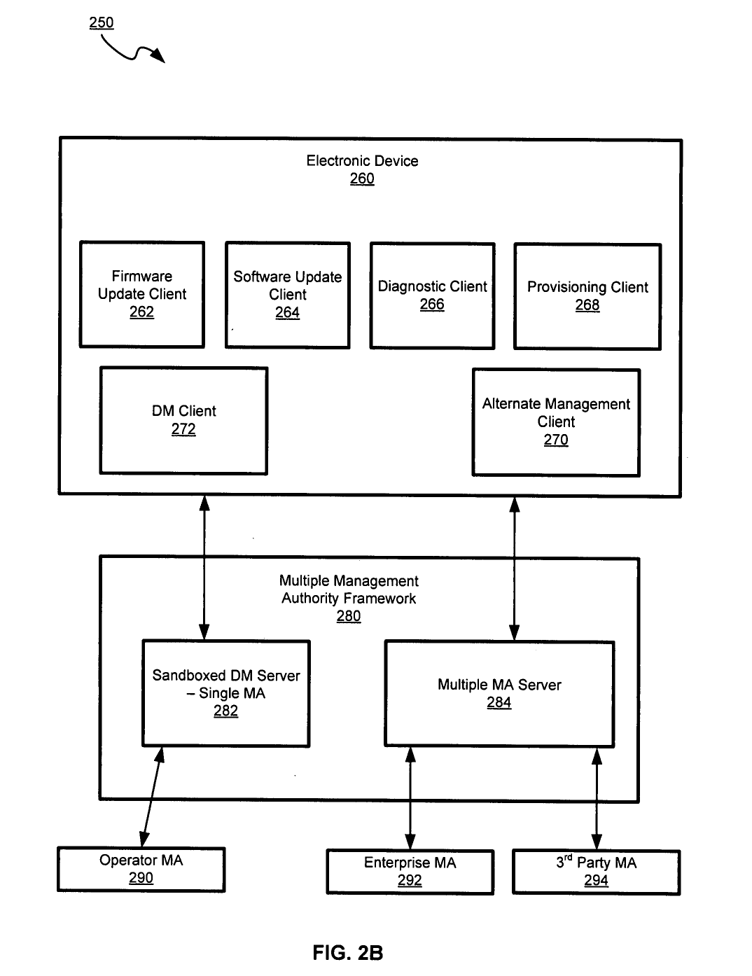

FIG. 2A is a perspective block diagram of an exemplary device management network that supports multiple management authorities, in accordance with an embodiment of the invention. As shown in the example of FIG. 2A, an embodiment of invention comprises a multiple management authority framework 230 communicatively coupled to one or more electronic devices 210. The multiple management authority framework 230 comprises an operator's DM server 232 that acts as one management authority, and an alternate management server 234 that acts as an alternate management authority.

Although only one alternate management server 234 is shown in FIG. 2A, this does not represent a specific limitation of an embodiment of the invention, a greater number of alternate management servers with alternate management authorities may be employed, without departing from the scope of an embodiment of the invention. For example, the multiple management authority framework 230 may support one or more additional alternate management servers 234 such as an enterprise DM server for an enterprise management authority.

As shown in FIG. 2A, an electronic device (e.g., electronic device 210) in accordance with an embodiment of the invention comprises a DM client 220 that may correspond to, for example, the DM client 134 of FIGS. 1A and 1B, and an alternate management client 222. Representative embodiments of the invention may also comprise a firmware update client 212, software update client 214, diagnostic client 216, and provisioning client 218.

In an embodiment of the invention, the alternate management server 234 interacts with the alternate management client 222 in the electronic device 210, using a management protocol 201. Elements of the management protocol 201 may be exchanged over a wired or wireless communication path such as those described above with respect to electronic device 120, for example. In some embodiments of the invention, the management protocol 201 is different from the OMA-DM protocol 203 employed by the operator's DM server 232 to interact with the DM client 220 in the electronic device 210. In other embodiments of the invention, the management protocol 201 may be the same as the OMA-DM protocol 203, and the DM client 220 and the alternate management client 222 may be combined, and may operate on the same server.

In some embodiments of the invention, both the DM client 220 and the alternate management client 222 employ the same client side agents to conduct device management operations on the electronic device 210. For example, the DM client 220 and the alternate management client 222 may both invoke the firmware update client 212 for firmware updates, the software update client 214 to conduct software component management (and software updates), the diagnostic client 216 to conduct device diagnostics and device monitoring, and the provisioning client 218 to conduct provisioning of the electronic device 210. Provisioning of the electronic device 210 may comprise, for example, client provisioning and/or continuous provisioning.

In one embodiment of the invention, the DM client 220 of electronic device 210 maintains a management tree (not shown) in the memory of the electronic device 210, for device management purposes. In some embodiments of the invention, such a device management tree is compatible with the Open Mobile Alliance (OMA) device management (DM) version 1.2 protocol. The device management tree is managed by the operator's DM server 232. An alternate management client such as the alternate management client 222 may maintain a different (logical) management tree for device management purposes that is managed by the alternate management server 234. In some embodiments of the invention, multiple management trees are combined into one overall logical management tree by the electronic device 210, but with total isolation between the sub-trees. Such isolation is not restricted solely to visibility of the sub-trees from the perspective of the operator's DM server 232 and any alternate management servers 234 that may be used, but also extends to access control and security aspects as well.

FIG. 2B is a perspective block diagram of an exemplary device management network that supports multiple management authorities using a multiple management authority framework, in accordance with an embodiment of the invention. Referring to FIG. 2B, there is shown an exemplary device management network 250 using a multiple management authority framework 280. The device management network 250 comprises an electronic device 260, and the multiple management authority framework 280. The electronic device 260, which may correspond to the electronic device 120 of FIGS. 1A and 1B, and/or the electronic device 210 of FIG. 2A, for example, comprises a DM client 272 and an alternate management client 270. The electronic device 260 also comprises a firmware update client 262, a software update client 264, a diagnostic client 266, and a provisioning client 268. As illustrated in FIG. 2B, the DM client 272 interacts with a sandboxed DM server 282 that operates on behalf of a single management authority, such as an operator's management authority system 290. The alternate management client 270 in the electronic device 260 inter acts with a multiple management authority server 284 that supports multiple management authorities such as, for example, the enterprise management authority system 292 and the 3rd party management authority system 294 shown in FIG. 2B.

The multiple management authority framework 280 in a representative embodiment of the present invention makes it possible to “sandbox” the DM server 282 that a management authority (e.g., an operator of the device management network 250) might use. The multiple management authority framework 280 provides isolation between the management tasks conducted by the sandboxed DM server 282, and those conducted by the multiple management authority server 234 of FIG. 2A. Such isolation is not restricted to, for example, visibility of configurations, settings, and security parameters, but also to management operations initiated such as diagnostics and firmware updates.

In an embodiment of the invention, the multiple management authority framework 280 coordinates execution of management activities that may be simultaneously initiated by both the sandboxed DM server 282 and those conducted by the multiple management authority server 284, especially in situations where such operations are likely to negatively impact the electronic device 260 or the user experience. For example, if a firmware update by the sandboxed DM server 282 is scheduled to overlap with a software component update by the multiple management authority server 284, the multiple management authority server 284 may modify the scheduling of such operations to avoid conflicts, or may warn the sandboxed DM server 282 and the multiple management authority server 284 on the existence of potential conflicts.

In some embodiments of the invention, the device management network 250 supports personalization by a subscriber of the configurations and “look and feel” of an electronic device such as the electronic device 260. Some examples of personalization features include:
a) a DM server such as the DM Server 282 or the alternate management server 284 proactively pushing content, firmware, software, and settings to the electronic device 260, based on personalized preferences of a user,
b) a personalization agent in the electronic device 260 such as, for example, the DM client 272 proactively pulling content to the electronic device 210,
c) aggregation and rating of mobile service offerings,
d) correlation of rated mobile service offerings with personalized preferences of a user,
e) a simplified user interface on the electronic device to aid a user in inputting personalized preferences,
f) use of voice recognition for inputting personalized preferences, and
g) using one or more algorithms to automatically create targeted services and features based on a few personalized preference inputs.

Personalization of an electronic device, in accordance with an embodiment of the invention, empowers subscribers to personalized selection of electronic device hardware, software, and content. Features of an electronic device such as, for example, the electronic device 120 of FIG. 1 may be targeted and administered at the individual subscriber level. A subscriber may embed in the electronic device only those features that they will use. In an embodiment of the invention, user preferences are stored on a device management server such as the device management server 102 of FIG. 1. User preferences may also be stored in an alternate management server such as the exemplary alternate management server 234 of FIG. 2A.

The user preferences may be provided by a subscriber via a client in the electronic device (e.g., the DM client 134 of FIG. 1), via a web portal and web browser, or via activation during a call to a customer care representative. The device management server (e.g., one or more of the multiple management authority server 284) may retrieve and compile information tailored to the user based on the stored preferences. The compiled information may then be pushed to the electronic device of the user (e.g., electronic device 260), and the user of the electronic device may be notified of its availability.

A device management network in accordance with the present invention such as the exemplary device management network 250 shown in FIG. 2B may also support, for example, concierge-type services. The following example illustrates one possible scenario supported by an embodiment of the invention. Upon activation of an electronic device such as the electronic device 260, a device management server such as, for example, the multiple management authority server 284 may cause a prompt message to be displayed on the electronic device 260, asking whether the user would like to personalize the electronic device.

If the user agrees, the user may be presented with a list of available interests including, for example, themes such as sports (e.g., FIFA World Cup soccer, NASCAR), parenting, movies, music (e.g., bands, venues), shopping, professions and special interests. A user may select a pre-packaged theme or interest from the list, and may then be presented with additional details to narrow the user selection. The selected interest may then be stored on a device management server such as the multiple management authority server 284, for example. Based on that selected preference, the electronic device of the subscriber may then receive an initial setup transaction updating firmware, software and settings (e.g., user interface or “skins”) of the electronic device with personalization packages for the selected preference. Later, the subscriber may be periodically notified of the availability of updates, according to any subscriptions in effect. This may include, for example, new applications, activities with subscribers that have indicated similar interests, scoring and statistics for games and tournaments, and advertising relating to “brick and mortar” vendors of goods and/or services related to the subscriber's preferences. Information for such notifications may be pro-actively retrieved and personalize based on the user preferences stored in, for example, the multiple management authority server 284, and may be delivered in the form of firmware/software/applications for the electronic device, alerts and advertising, and may include streaming forms of media content.

By personalizing the electronic device 260, and providing information to a subscriber based upon user preferences, an embodiment of the invention provides only relevant data and minimizes user interaction. The latter may be important to a subscriber, due to the fact that most electronic devices in mass use for the delivery of services and application (e.g., cellular phones, personal digital assistants, personal computers, and pagers) have limited input capabilities. Delivery of information may be via a TCP/IP connection, or via short message service (SMS). Mobile-originated device management sessions may be employed to track electronic device such as the electronic device 260.

An embodiment of the invention provides a user-friendly way to personalize an electronic device such as the electronic 260. This personalization may comprise automatically fetching features, provisioning, and content, based on stored user preferences. Targeted advertising is also enabled by an embodiment of the invention, using preference-based advertising. In some embodiments of the invention, a device management server such as the multiple management authority server 284 provides a “most popular” or “what's hot” option, that can be used to actively provide the most popular applications and content, for example. Users may share preferences with other users via, for example, a “send to a friend” functionality, enabling the spread of information and growth of common interest groups. Preferences may also be shared on community services/social web sites.

In some embodiments of the invention, the device management network 250 supports graphical alerts. This feature may use, for example, OMA-DM Alert Codes to produce graphical alerts in the electronic device 260, rather than employing simple text-only messages. This feature is useful for several different applications including, for example:

A) Server pushing instructional information with graphics, and

B) Server pushing advertising.

A DM server such as the multiple management authority server 284 may invoke a graphical alert in the device 260 comprises by sending an OMA-DM message, such as the extensible markup language (XML) example shown in Listing 1, below.

Listing 1.

<Alert>
<CmdID>2</CmdID>
<Data>1100</Data>
<Item><Data>MINDT=10</Data></Item>
<Item>
<Meta>
<Format xmlns=“syncml:metinf”>b64</Format>
<Type xmlns=“syncml:metinf”>image/jpeg</Type>
<Size xmlns=“syncml:metinf”>37264</Size>
</Meta>
<Data>[binary image data]</Data>
</Item>
</Alert>

A device management network in accordance with an embodiment of the invention such as, for example, the device management network 250, may support multiple choices using, for example, the XML sequence shown in Listing 2, below.

Listing 2.

<Alert>
<CmdID>2</CmdID>
<Data>1104</Data>
<Item></Item>
<Item><Data>Select service to configure</Data></Item>
<Item>
<Meta>
<Format xmlns=“syncml:metinf”>b64</Format>
<Type xmlns=“syncml:metinf”>image/jpeg</Type>
<Size xmlns=“syncml:metinf”>37264</Size>
</Meta>
<Data>[binary image data1]</Data>
</Item>
<Item>
<Meta>
<Format xmlns=“syncml:metinf”>b64</Format>
<Type xmlns=“syncml:metinf”>image/jpeg</Type>
<Size xmlns=“syncml:metinf”>37264</Size>
</Meta>
<Data>[binary image data2]</Data>
</Item>
<Item>
<Meta>
<Format xmlns=“syncml:metinf”>b64</Format>
<Type xmlns=“syncml:metinf”>image/jpeg</Type>
<Size xmlns=“syncml:metinf”>37264</Size>
</Meta>
<Data>[binary image data3]</Data>
</Item>
<Item>
<Meta>
<Format xmlns=“syncml:metinf”>b64</Format>
<Type xmlns=“syncml:metinf”>image/jpeg</Type>
<Size xmlns=“syncml:metinf”>37264</Size>
</Meta>
<Data>[binary image data4]</Data>
</Item>
</Alert>

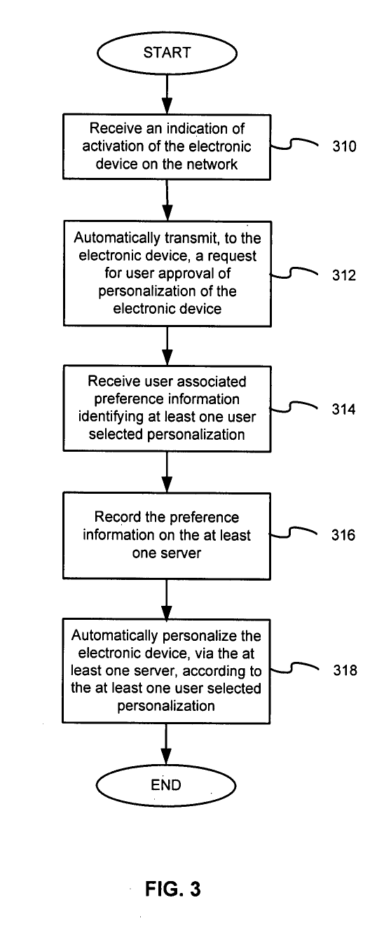

FIG. 3 is a flowchart of an exemplary method supporting delivery of personalized information via a network from at least one server to an electronic device of a user, in accordance with an embodiment of the invention. The server(s) may comprise a device management server such as, for example, the DM server 102 of FIG. 1 or multiple management authority server 284 of FIG. 2B. In step 310, the DM server receives an indication of activation of the electronic device on the network. Next, in step 312, the DM server automatically transmits to the electronic device a request for user approval of personalization of the electronic device. In step 314, the DM server receives user associated preference information identifying at least one user selected personalization. Then, in step 316, the method records the preference information on the server(s). Finally, in step 318, the method automatically personalizes the electronic device, via the server(s), according to the selected personalization(s).

Various embodiments of the invention may be seen in a system supporting delivery of personalized information via an electronic device of a user. In some embodiments of the invention, the system comprises at least one server communicatively coupled to the electronic device via a network. The server(s) of such an embodiment is operable to, at least, receive preference information associated with a user, automatically activate at least one network-based service for the user according to the user associated preference information, and automatically distribute update information to the electronic device that enables user access to the network-based service(s).

The server(s) of such an embodiment of the invention is also operable to, at least, retrieve information identifying content available from the network-based service(s), aggregate the retrieved information to produce a content update, and transmit the content update to the electronic device according to the preference information associated with the user. In various representative embodiments of the present invention, the electronic device may be a mobile device, and may comprise one of a cellular phone, a personal digital assistant, and a pager, and the network may be a wireless network. The preference information may be received via the electronic device, and the update information may update one or more of program code, information for display, audio information for playback, and/or settings, of the electronic device. The retrieving may be performed periodically, according to the preference information. The server(s) may comprise a device management server compliant with the Open Mobile Alliance (OMA) version 1.2 or earlier device management protocol.

Additional aspects of representative embodiments of the present invention may be found in a method supporting delivery of personalized information via a network from at least one server to an electronic device of a user. In some embodiments of the invention, the method comprises receiving an indication of activation of the electronic device on the network, automatically transmitting to the electronic device a request for user approval of personalization of the electronic device, and receiving user associated preference information identifying at least one user selected personalization. Some embodiments of the invention may also comprise recording the preference information on the server(s), and automatically personalizing the electronic device, via the server(s), according to the user selected personalization(s).

An embodiment of the invention may also comprise automatically activating at least one network-based service, according to the preference information. Personalizing may comprise updating one or more of program code, information for display, audio information for playback, and/or settings of the electronic device, and the electronic device may comprise one of a cellular phone, a personal digital assistant, and a pager. The network may be a wireless network, and the preference information may be received via the electronic device. In some embodiments of the invention the method also comprises automatically removing, from the electronic device, personalizations for a prior user of the electronic device. Personalizations may comprise updates to one or more of program code, information for display, audio information for playback, and/or settings of the electronic device.

Yet other aspects of the present invention may be seen in an electronic device supporting personalization associated with a user. An electronic device in accordance with some embodiments of the invention comprises at least one processor communicatively coupled via a network to at least one server. The processor(s) may be operable to at least receive a request for user approval of personalization of the electronic device, prompt the user for information identifying at least one user associated preference, and transmit the preference information to the server(s). The processor(s) of various embodiments of the invention is operable to, at least, receive update information provided by the server(s) using the preference information, and personalize the electronic device using the received update information, wherein the personalization enables user access to network-based service(s). The personalization may comprise updating one or more of program code, information for display, audio information for playback, and/or settings of the electronic device, the electronic device may comprise one of a cellular phone, a personal digital assistant, and a pager, and the network may be a wireless network.

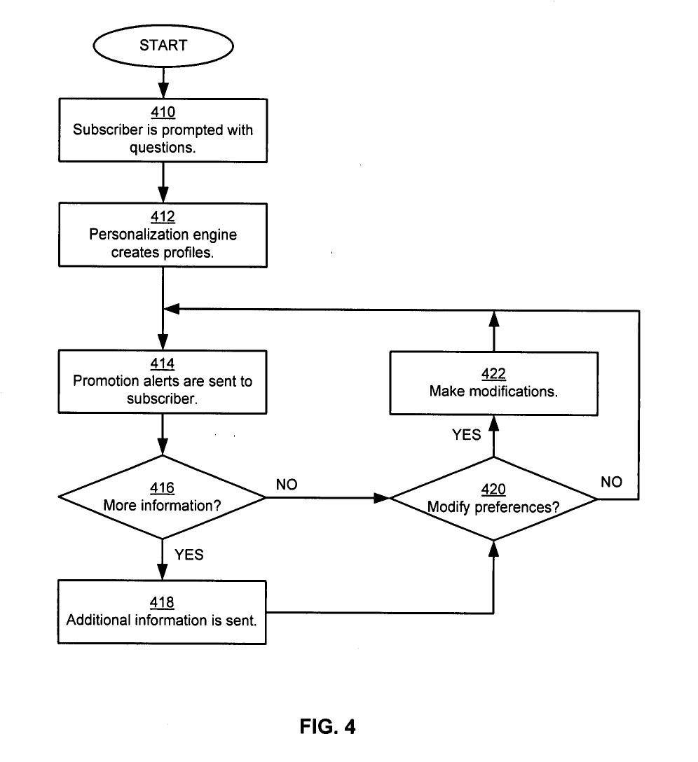

FIG. 4 is a flowchart of an exemplary method to push promotions based on user input preferences, in accordance with an embodiment of the invention. In step 410, a subscriber has an electronic device, for example, the electronic device 120, which has not yet been activated. Upon activation, the subscriber may be prompted with questions, where the questions may be pre-loaded in the electronic device 120 and/or downloaded via the communication paths 101, 103, 105, and/or 107.

The questions can be presented to the user, for example, via a web portal or be OMA-DM user interaction alert driven and can be viewed on the video display 126. The subscriber can answer the questions, for example, by using the keypad 128, and the answers may be uploaded via the communication paths 101, 103, 105, and/or 107. Some representative embodiments of the invention may comprise, for example, a touch-sensitive screen for the video display 126. Accordingly, the user of the electronic device 120 may input data by touching appropriate portions of the video display 126.

In step 412, a portion of the network 100, such as, for example, the personalization engine 170, can process the answers and generate one or more profiles that may correspond to the electronic device 120 owned by the subscriber and/or the subscriber. The profiles may comprise, for example, preferred stores, hobbies, etc.

In step 414, promotion alerts may be sent to the subscriber, where the promotions may be based on, for example, the subscriber's present location, the electronic device, and/or profiles. The promotion alerts may be, for example, GUI alerts. The promotion alert can be a result of the advertisement and promotion and rating block 176 determining, for example, that a particular promotion is suitable for the specific subscriber. Once the determination is made, the deployment and response engine 178 can handle the deployment of the promotion to the subscriber. As an example, the profile may indicate that the subscriber is interested in a certain type of music, such as rap, and that the electronic device 120 is capable of playing MP3 music. Accordingly, if a web music store is having a promotion for rap music, an alert about the promotion can be communicated to the subscriber via his electronic device 120. The deployment and response engine 178 may also determine what the take rate may be for a particular promotion.

In step 416, after the promotion alert is downloaded to the subscriber, the subscriber is asked whether he wants more information on the promotion. The user can answer “Yes” or “No” by, for example, pressing appropriate keys, which may be soft keys. If the subscriber answers “Yes,” the next step is step 418. If the subscriber answers “No,” the next step is step 420. In step 418, additional information is sent to the user. The information may comprise, for example, specific artists being promoted, and/or promotion keys that may be needed for purchasing the promoted music. The information can be displayed via the web browser or additional OMA_DM alerts.

In step 420, the user can decide whether to modify his preferences. If the user does wish to make modification to his preferences, the next step is step 422. Otherwise, the next step is step 414 where further promotions, as available, may be sent to the electronic device 120 based on the present preferences.

In step 422, the user can make modifications to his preferences. The change in preferences may result in change in the subscriber profiles, where the change can be allowed by the subscriber profile management and repository block 172. The preferences data can be stored in the electronic device 120 for uploading at a later time, or the electronic device 120 may communicate with the network 100 to make modifications to the preferences data base. Some representative embodiments of the invention may allow the subscriber to make modifications, for example, on a web portal, via the electronic device 120 or another device that can access the web, or default to basic preferences via, for example, OMA_DM user interaction alerts. The next step is step 414 where further promotions, as available, may be sent based on the modified preferences.

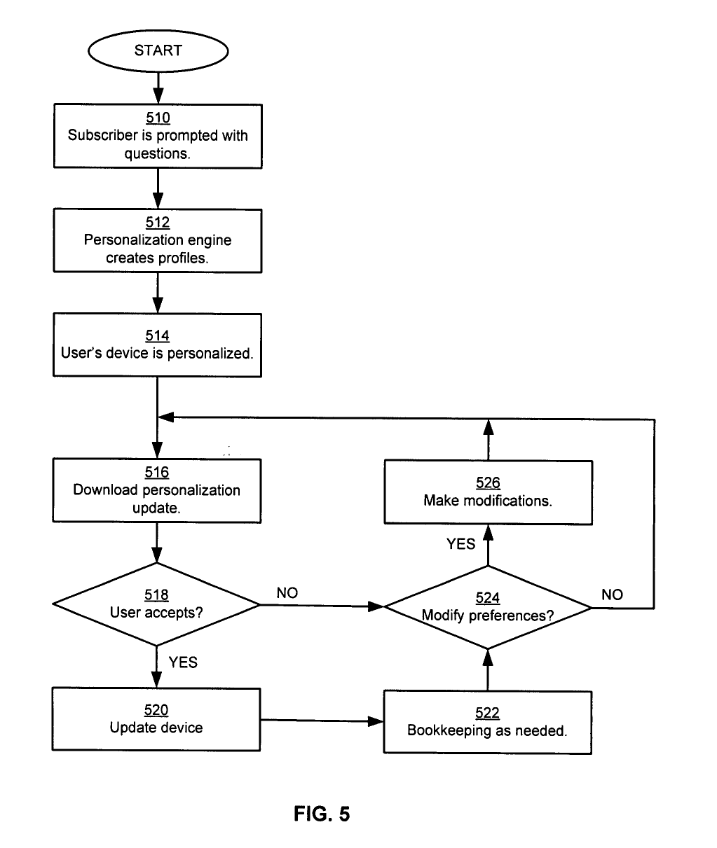

FIG. 5 is a flowchart of an exemplary method for dynamic personalized content of user input preferences, in accordance with an embodiment of the invention. In step 510, a subscriber has an electronic device, for example, the electronic device 120, which has not yet been activated. Upon activation, the subscriber is prompted with questions, where the questions may be pre-loaded in the electronic device 120 and/or downloaded via the communication paths 101, 103, 105, and/or 107. The subscriber may answer the questions and the answers may be uploaded via the communication paths 101, 103, 105, and/or 107.

The questions can be presented to the user via a web portal or be OMA-DM user interaction alert driven and can be viewed on the video display 126, for example. The subscriber can answer the questions by, for example, using the keypad 128. Some embodiments of the invention may comprise, for example, a touch-sensitive screen for the video display 126. Accordingly, the user of the electronic device 120 may be able to input data by touching appropriate portions of the video display 126.

In step 512, a portion of the network 100, such as, for example, the personalization engine 170, can process the answers and may generate one or more profiles that correspond to the electronic device 120 owned by the subscriber and/or the subscriber. The profiles may comprise, for example, preferred songs, groups of families, friends, etc.

In step 514, the electronic device 120 owned by the subscriber is personalized with subscriber specific content. The subscriber specific content can be generated by, for example, the content aggregation and rating block 174. The deployment of the subscriber specific content can be handled by, for example, the deployment and response engine 178. For example, the electronic device 120 can be loaded with specific songs, or songs from different music genres that may be used as ring-tones, and different ring-tones may be associated with different groups of friends. Accordingly, a subscriber can identify which person or which group may be calling him by the ring-tone. The personalized content may also comprise, for example, wallpapers, browser bookmarks, home screen shortcuts, and/or soft keys. The personalized content may be labeled as, for example, “my ring tone,” “my wallpaper,” etc.

In step 516, the personalization of the electronic device 120 can be updated as new content becomes available that matches the subscriber's profiles. The personalization update may be downloaded to the electronic device, but not yet activated. The subscriber may then be given a description of the update and asked if the subscriber wishes the update. The update may be, for example, a latest song by a preferred singer. Other information may also be displayed. For example, if the update is a song, there may be a charge for the song.

In step 518, the user can decide whether to accept the update or not. If the subscriber answers “Yes,” the next step is step 520. If the subscriber answers “No,” the next step is step 524. In step 520, the downloaded update is activated. The deployment and response engine 178 can also determine what the take rate may be for the subscriber specific content. Other embodiments of the invention may display the update information without downloading the update. Then, when the subscriber does answer “Yes,” the downloading and activation can take place.

In step 522, appropriate portions of the network 100 can be updated with the sum to be charged to the subscriber's account. In step 524, the subscriber can decide whether to modify his preferences. If the subscriber does wish to make modification to his preferences, the next step is step 526. Otherwise, the next step is step 516 where personalization updates, as available, is sent to the electronic device 120 based on the present preferences.

In step 526, the user is able to make modifications to his preferences. The preferences data may be stored in the electronic device 120 for uploading at a later time, or the electronic device 120 may communicate with the network 100 to make modifications to the preferences data base. The subscriber may also make modifications, for example, on a web portal, via the electronic device 120 or another device that can access the web, or default to basic preferences via, for example, OMA_DM user interaction alerts. The change in preferences may result in change in the subscriber profiles, where the change may be allowed by the subscriber profile management and repository block 172. The next step is step 516 where personalization updates, as available, can be sent to the electronic device 120 based on the modified preferences.

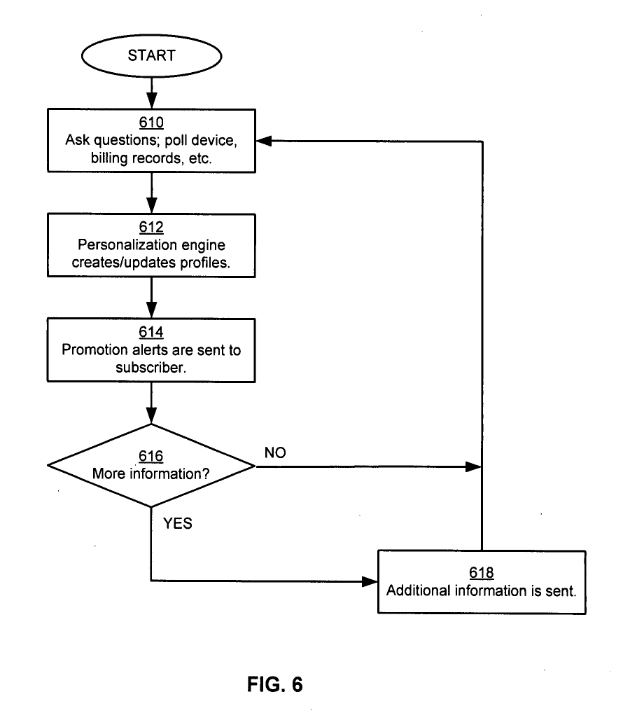

FIG. 6 is a flowchart of an exemplary method to push promotions based on auto-derived preferences, in accordance with an embodiment of the invention. In step 610, a subscriber has an electronic device, for example, the electronic device 120, which has not yet been activated. Upon activation, the electronic device 120 is polled by, for example, the device management server 102. Some of the information collected during polling may be device type, features supported by the device, amount of memory, applications on the device, etc. Various servers in the network 100 may also gather other information from, for example, the browser cache, billing records, service subscription records, and portal content downloaded. However, since the subscriber may be new to using the network 100, there may not be much information in the various databases. The subscriber may then be asked questions, and the answers to these questions can be uploaded via the communication paths 101, 103, 105, and/or 107.

The questions may be presented to the user via a web portal or be OMA-DM user interaction alert driven and may be viewed on the video display 126, for example. The subscriber can answer the questions by, for example, using the keypad 128. Some embodiments of the invention may comprise, for example, a touch-sensitive screen for the video display 126. Accordingly, the user of the electronic device 120 can input data by touching appropriate portions of the video display 126.

In step 612, a portion of the network 100, such as, for example, the personalization engine 170, can process the answers, and other information gathered from the various databases, and generate one or more profiles that correspond to the electronic device 120 owned by the subscriber and/or the subscriber. The profiles may be, for example, preferred stores, hobbies, etc. Updates to the profiles may be managed by, for example, the subscriber profile management and repository block 172.

In step 614, promotion alerts are sent to the subscriber, where the promotions can be based on, for example, the subscriber's present location, the electronic device, and/or profiles. The promotion alert is a result of the advertisement and promotion and rating block 176 determining, for example, that a promotion may be suitable for the specific subscriber. Once the determination is made, the deployment and response engine 178 can handle the deployment of the promotion to the subscriber. For example, the profile may indicate that the subscriber is interested in a certain type of music, such as rap, and that the electronic device 120 is capable of playing MP3 music. Accordingly, if a web music store is having a promotion for rap music, an alert about the promotion can be communicated to the subscriber via his electronic device 120.

In step 616, after the promotion alert is downloaded to the subscriber, the subscriber may be asked whether he wants more information on the promotion. The user can answer “Yes” or “No” by, for example, pressing appropriate keys, which may be soft keys. If the subscriber answers “Yes,” the next step is step 618. If the subscriber does not wish additional information, the next step is step 610. In step 618, additional information is sent to the user. The information may comprise, for example, specific artists being promoted, and/or promotion keys that may be needed for purchasing the promoted music. The deployment and response engine 178 may also determine what the take rate may be for the promotion.

While an embodiment of the invention has been described where the electronic device 120 is polled upon first being activated to gather profile information, the invention need not be so limited. For example, the subscriber may also be asked to answer various questions in order to gather initial data, as well as various data bases being polled.

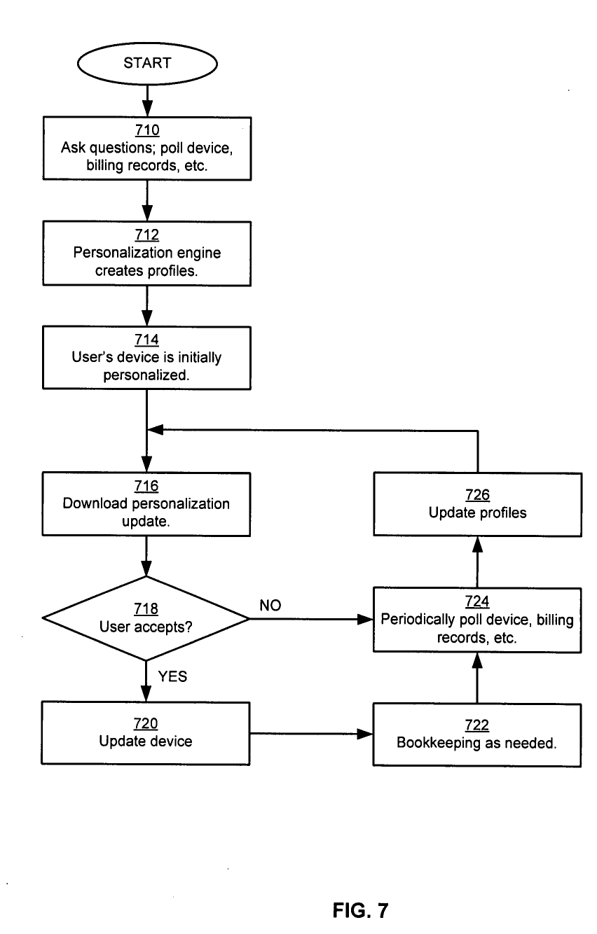

FIG. 7 is a flowchart of an exemplary method for dynamic personalized content of auto-derived preferences, in accordance with an embodiment of the invention. In step 710, a subscriber has an electronic device, for example, the electronic device 120, which has not yet been activated. Upon activation, the electronic device 120 is polled by, for example, the device management server 102. Some of the information collected during polling may be device type, features supported by the device, amount of memory, applications on the device, etc. Various servers in the network 100 may also gather other information from, for example, the browser cache, billing records, service subscription records, and portal content downloaded. However, since the subscriber may be new to using the network 100, there may not be much information in the various databases. The subscriber is then asked questions, and the answers to these questions can be uploaded via the communication paths 101, 103, 105, and/or 107.

The questions may be presented to the user via a web portal or be OMA-DM user interaction alert driven and viewed on the video display 126, for example. The subscriber can answer the questions by, for example, using the keypad 128. Some embodiments of the invention may comprise, for example, a touch-sensitive screen for the video display 126. Accordingly, the user of the electronic device 120 can input data by touching appropriate portions of the video display 126.

In step 712, a portion of the network 100, such as, for example, the personalization engine 170, can process the answers, and other information gathered from the various databases, and generate one or more profiles that correspond to the electronic device 120 owned by the subscriber and/or the subscriber. The profiles may be, for example, preferred songs, groups of families, friends, etc.

In step 714, the electronic device 120 owned by the subscriber is personalized. For example, the electronic device 120 may be loaded with specific songs, or songs from different music genres that may be used as ring-tones, and different ring-tones may be associated with different groups of friends. Accordingly, a subscriber may be able to identify which person or which group may be calling him by the ring-tone. The personalized content may also comprise, for example, wallpapers, browser bookmarks, home screen shortcuts, and/or soft keys. The personalized content may be labeled as, for example, “my ring tone,” “my wallpaper,” etc. The subscriber specific content can be generated by, for example, the content aggregation and rating block 174.

In step 716, the personalization of the electronic device 120 can be updated as new content becomes available that matches the subscriber's profiles. The content aggregation and rating block 174 may categorize the new content as to whether it may be suitable for a subscriber. The deployment of the subscriber specific content can be handled, for example, by the deployment and response engine 178. The personalization update may be downloaded to the electronic device, but not yet activated. The subscriber may then be given a description of the update and asked if the subscriber wishes the update. The update may be, for example, a latest song by a preferred singer. Other information can also be displayed. For example, if the update is a song, there may be a charge for the song.

In step 718, the user can decide whether to accept the update or not. If the subscriber answers “Yes,” the next step is step 720. If the subscriber answers “No,” the next step is step 724. In step 720, the downloaded update is activated. The deployment and response engine 178 may also determine what the take rate may be for the subscriber specific content. Other embodiments of the invention may display the update information without downloading the update. Then, when the subscriber does answer “Yes,” the downloading and activation takes place.

In step 722, appropriate portions of the network 100 are updated with the sum to be charged to the subscriber's account. In step 724, the electronic device 120 can be periodically polled by, for example, the device management server 102. Some of the information collected during polling may be device type, features supported by the device, amount of memory, applications on the device, etc. Various servers in the network 100 may also gather other information from, for example, the browser cache, billing records, service subscription records, and portal content downloaded. In step 726, the subscriber profiles are updated with any new information collected in step 724. The change in the subscriber profiles may be allowed by the subscriber profile management and repository block 172. The next step is step 716.

While an embodiment of the invention has been described where the electronic device 120 is polled upon first being activated to gather profile information, the invention need not be so-limited. For example, the subscriber may also be asked to answer various questions in order to gather initial data, as well as various data bases being polled.

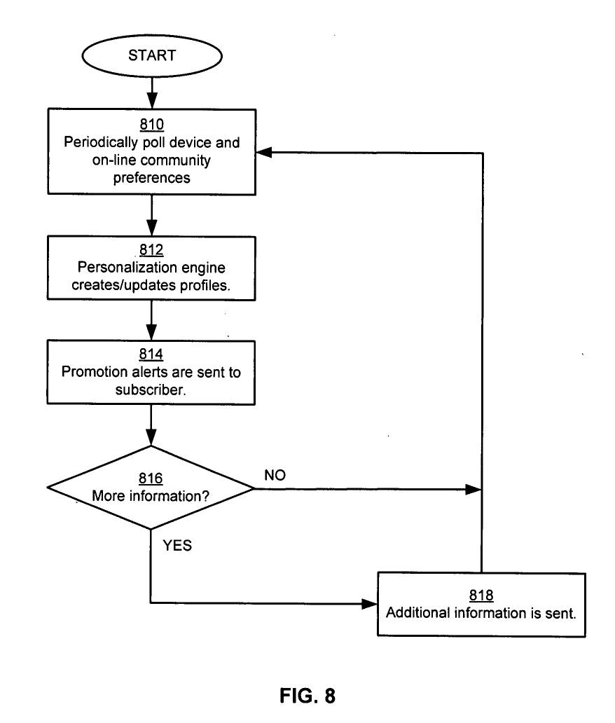

FIG. 8 is a flowchart of an exemplary method to push promotions based on on-line community preferences, in accordance with an embodiment of the invention. In step 810, a subscriber has an electronic device, for example, the electronic device 120, which has not yet been activated. Upon activation, the electronic device 120 is polled by, for example, the device management server 102. Some of the information collected during polling may be device type, features supported by the device, amount of memory, applications on the device, etc. Various servers in the network 100 may also gather other information from, for example, the browser cache, billing records, service subscription records, and portal content downloaded. However, since the subscriber may be new to using the network 100, there may not be much information in the various databases.

Information can also be gathered from preferred on-line sites, such as, for example, myspace, facebook, etc., that the subscriber may designate. The interface for designating the preferred on-line site may be via a web portal or be OMA-DM user interaction alert driven. The subscriber may enter a URL by, for example, using the keypad 128. Some embodiments of the invention may comprise, for example, a touch-sensitive screen for the video display 126. Accordingly, the user of the electronic device 120 can input data by touching appropriate portions of the video display 126.

In step 812, a portion of the network 100, such as, for example, the personalization engine 170, can process the information gathered from the various databases and/or website(s), and generate one or more profiles that may correspond to the electronic device 120 owned by the subscriber and/or the subscriber. The profiles may be, for example, preferred stores, hobbies, etc.

In step 814, promotion alerts can be sent to the subscriber, where the promotions may be based on, for example, the subscriber's present location, the electronic device, and/or profiles. The promotion alert is a result of the advertisement and promotion and rating block 176 determining, for example, that a promotion is suitable for the specific subscriber. Once the determination is made, the deployment and response engine 178 can handle the deployment of the promotion to the subscriber. For example, the profile may indicate that the subscriber is interested in a certain type of music, such as rap, and that the electronic device 120 is capable of playing MP3 music. Accordingly, if a web music store is having a promotion for rap music, an alert about the promotion may be communicated to the subscriber via his electronic device 120.

In step 816, after the promotion alert is downloaded to the subscriber, the subscriber is asked whether he wants more information on the promotion. The user may answer “Yes” or “No” by, for example, pressing appropriate soft keys. If the subscriber answers “Yes,” the next step is step 818. The deployment and response engine 178 may also determine what the take rate may be for the promotion. If the subscriber does not wish additional information, the next step is step 810. In step 818, additional information is sent to the user. The information may comprise, for example, specific artists being promoted, and/or promotion keys that may be needed for purchasing the promoted music. This may result in the step 816 updating the subscriber's profiles. The updates to the subscriber profiles may be allowed by the subscriber profile management and repository block 172.

While an embodiment of the invention has been described where the electronic device 120 is polled upon first being activated to gather profile information, the invention need not be so limited. For example, the subscriber may also be asked to answer various questions in order to gather initial data, as well as various data bases being polled.

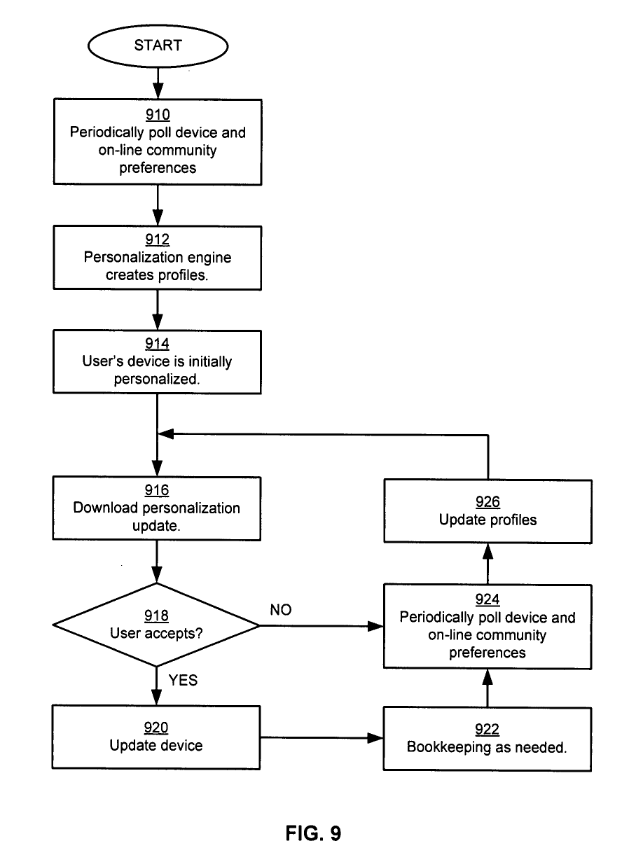

FIG. 9 is a flowchart of an exemplary method for dynamic personalized content of auto-derived preferences and on-line community preferences, in accordance with an embodiment of the present invention. In step 910, a subscriber has an electronic device, for example, the electronic device 120, which has not yet been activated. Upon activation, the electronic device 120 is polled by, for example, the device management server 102. Some of the information collected during polling may be device type, features supported by the device, amount of memory, applications on the device, etc. Various servers in the network 100 may also gather other information from, for example, the browser cache, billing records, service subscription records, and portal content downloaded. However, since the subscriber may be new to using the network 100, there may not be much information in the various databases.

Information can also be gathered from on-line sites, such as, for example, myspace, facebook, etc., that the subscriber may designate. The interface for designating the preferred on-line site may be via a web portal or be OMA-DM user interaction alert driven. The subscriber can enter a URL by, for example, using the keypad 128. Some embodiments of the invention may comprise, for example, a touch-sensitive screen for the video display 126. Accordingly, the user of the electronic device 120 can input data by touching appropriate portions of the video display 126.

In step 912, a portion of the network 100, such as, for example, the personalization engine 170, can process the information gathered from the various databases and/or website(s), and generate one or more profiles that correspond to the electronic device 120 owned by the subscriber. The profiles may be, for example, preferred songs, groups of families, friends, etc.

In step 914, the electronic device 120 owned by the subscriber is personalized. For example, the electronic device 120 may be loaded with specific songs, or songs from different music genres that may be used as ring-tones, and different ring-tones may be associated with different groups of friends. Accordingly, a subscriber may be able to identify which person or which group may be calling him by the ring-tone. The personalized content may also comprise, for example, wallpapers, browser bookmarks, home screen shortcuts, and/or soft keys. The personalized content may be labeled as, for example, “my ring tone,” “my wallpaper,” etc. The subscriber specific content is generated by, for example, the content aggregation and rating block 174. The deployment of the subscriber specific content is handled by the deployment and response engine 178.

In step 916, the personalization of the electronic device 120 can be updated as new content becomes available that matches the subscriber's profiles. The content aggregation and rating block 174 can determine, for example, whether new content may be appropriate for a subscriber. The personalization update may be downloaded to the electronic device, but not yet activated. The subscriber may then be given a description of the update and asked if the subscriber wishes the update. The update may be, for example, a latest song by a preferred singer. Other information can also be displayed. For example, if the update is a song, there may be a charge for the song.

In step 918, the user may decide whether to accept the update or not. If the subscriber answers “Yes,” the next step is step 920. If the subscriber answers “No,” the next step is step 924. In step 920, the downloaded update is activated. The deployment and response engine 178 may also determine what the take rate may be for the subscriber specific content. Other embodiments of the invention may display the update information without downloading the update. Then, when the subscriber does answer “Yes,” the downloading and activation may take place.

In step 922, appropriate portions of the network 100 are updated with the sum to be charged to the subscriber's account. In step 924, the electronic device 120 may be periodically polled by, for example, the device management server 102. Some of the information collected during polling may be device type, features supported by the device, amount of memory, applications on the device, etc. Various servers in the network 100 can also gather other information from, for example, the browser cache, billing records, service subscription records, and portal content downloaded. In step 926, the subscriber profiles are updated with any new information collected in step 924. The updates to the subscriber profiles may be allowed by the subscriber profile management and repository block 172. The next step is step 916.

While an embodiment of the invention has been described where the electronic device 120 is polled upon first being activated to gather profile information, the invention need not be so limited. For example, the subscriber may also be asked to answer various questions in order to gather initial data, as well as various data bases being polled.

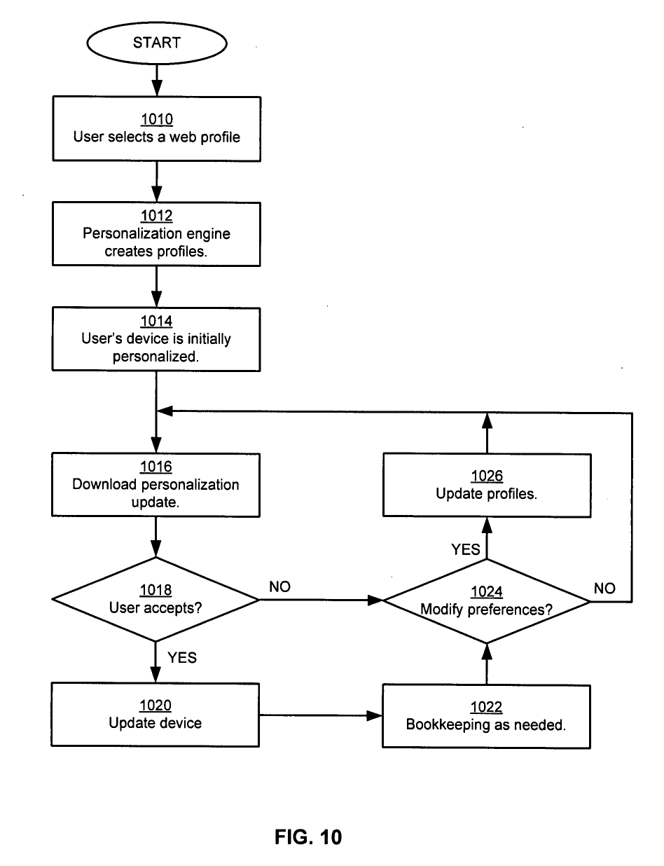

FIG. 10 is a flowchart of an exemplary method for personal profile sharing, in accordance with an embodiment of the invention. In step 101, a subscriber has an electronic device, such as, for example, the electronic device 120, which has not yet been activated. As part of activation, the subscriber can select a web profile for use in generating the subscriber's profile for use with the electronic device 120. The selected web profile may be, for example, a profile of another subscriber that is accessible to the first subscriber. The selected web profile may also be a celebrity's web profile or on-line sites, such as, for example, myspace, facebook, etc., that the subscriber may designate. The selected web profile can also be generated by the subscriber as part of activation.

Generation of the profile may be started, for example, by answering questions that may be stored on the electronic device 120, or downloaded by at least one of the servers in the network 100. The subscriber profile may be stored on a server, such as, for example, the customer care server 108. This profile, or portions of the profile, may be allowed to be shared with other subscribers on the network 100.

The interface for designating the preferred on-line site may be via a web portal or be OMA-DM user interaction alert driven. The subscriber may enter a URL by, for example, using the keypad 128. Some embodiments of the invention may comprise, for example, a touch-sensitive screen for the video display 126. Accordingly, the user of the electronic device 120 can input data by touching appropriate portions of the video display 126.

In step 1012, a portion of the network 100, such as, for example, the personalization engine 170, can process the information gathered from the website(s), and generate one or more profiles that may correspond to the electronic device 120 owned by the subscriber and/or the subscriber. The profiles may be, for example, preferred songs, groups of families, friends, etc.

In step 1014, the electronic device 120 owned by the subscriber is personalized. For example, the electronic device 120 may be loaded with specific songs, or songs from different music genres that may be used as ring-tones, and different ring-tones may be associated with different groups of friends. Accordingly, a subscriber may be able to identify which person or which group may be calling him by the ring-tone. The personalized content may also comprise, for example, wallpapers, browser bookmarks, home screen shortcuts, and/or soft keys. The personalized content may be labeled as, for example, “my ring tone,” “my wallpaper,” etc. The subscriber specific content can be generated by, for example, the content aggregation and rating block 174. The deployment of the subscriber specific content can be handled by, for example, the deployment and response engine 178.

In step 1016, the personalization of the electronic device 120 can be updated as new content becomes available that matches the subscriber's profiles. The content aggregation and rating block 174 can determine, for example, whether new content may be appropriate for a subscriber. The personalization update may be downloaded to the electronic device, but not yet activated. The subscriber may then be given a description of the update and asked if the subscriber wishes the update. The update may be, for example, a latest song by a preferred singer. Other information may also be displayed. For example, if the update is a song, there may be a charge for the song.

In step 1018, the user may decide whether to accept the update or not. If the subscriber answers “Yes,” the next step is step 1020. If the subscriber answers “No,” the next step is step 1024. In step 1020, the downloaded update is activated. The deployment and response engine 178 may also determine what the take rate may be for the promotion/subscriber specific content. Other embodiments of the invention may display the update information without downloading the update. Then, when the subscriber does answer “Yes,” the downloading and activation can take place.

In step 1022, appropriate portions of the network 100 are updated with the sum to be charged to the subscriber's account. In step 1024, the subscriber can make changes to his web profile. In step 1026, the changes to the profile may be used to modify the subscriber profiles. The updates to the subscriber profiles may be allowed by the subscriber profile management and repository block 172. The next step is step 1016 where personalization update may occur based on changes to the subscriber profiles.

While various embodiments of the invention have been described with respect to FIGS. 1A-10, the invention need not be so limited. For example, while FIG. 10 describes using a web profile to generate a subscriber profile, other embodiments of the invention may also use various techniques described with respect to FIGS. 4-10. For example, some of the techniques that can be used are polling and querying the subscriber with questions. Various embodiments of the invention may also provide personalized content and/or push promotions/advertisements.

Although a system and method according to the present invention has been described in connection with the preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for interfacing to an electronic device, the method comprising:
gathering information that corresponds to one or both of: the electronic device and/or a user of the electronic device;
generating one or more user profiles based on said gathered information; and
communicating information to the electronic device based on said one or more user profiles.

2. The method according to claim 1, wherein the electronic device is a mobile terminal.

3. The method according to claim 1, comprising:
providing questions for said user of the electronic device to answer, for said gathering information.

4. The method according to claim 1, comprising:
querying one or more databases, which are communicatively coupled to a network to which the electronic device is communicatively coupled, for information regarding one or both of: the electronic device and/or said user of the electronic device.

5. The method according to claim 4, wherein said one or more databases comprise one or more of: billing records, service subscription records, and/or user profile records.

6. The method according to claim 1, wherein said communicated information is one or both of: a promotion and/or user specific content.

7. The method according to claim 1, comprising:
querying the electronic device for device specific information, for said gathering information.

8. The method according to claim 1, wherein said one or more user profiles are based on at least one user profile specified by said user of the electronic device.

9. The method according to claim 1, wherein said gathered information is from one or more websites specified by said user.

10. The method according to claim 1, comprising:
presenting an option to said user of the electronic device to accept one or both of: a promotion and/or user specific content.

11. A system for interfacing to an electronic device, the system comprising:
one or more servers that enable gathering of information that corresponds to one or both of: the electronic device and/or a user of the electronic device;
wherein said one or more servers enable generation of one or more user profiles based on said gathered information; and
wherein said one or more servers enable communication of information to the electronic device based on said one or more user profiles.

12. The system according to claim 11, wherein the electronic device is a mobile terminal.

13. The system according to claim 11, wherein said one or more servers enable providing of questions for said user of the electronic device to answer.

14. The system according to claim 11, wherein said one or more servers enable querying of one or more databases, which are communicatively coupled to a network to which the electronic device is communicatively coupled, for information regarding one or both of: the electronic device and/or said user of the electronic device.

15. The system according to claim 14, wherein said one or more databases comprise one or more of billing records, service subscription records, and/or user profile records.

16. The system according to claim 11, wherein said communicated information is one or both of: a promotion and/or user specific content.

17. The system according to claim 11, wherein said one or more servers enable querying of the electronic device for device specific information.

18. The system according to claim 11, wherein said one or more user profiles are based on at least one user profile specified by said user of the electronic device.

19. The system according to claim 11, wherein said gathered information is from one or more websites specified by said user.

20. The system according to claim 11, wherein said one or more servers enable presentation of an option to said user of the electronic device to accept one or both of: a promotion and/or user specific content.
